(19) United States
(12) Patent Application Publication
(10) Pub. No.: US 2010/0247907 A1
(43) Pub. Date: Sep. 30, 2010

(54) PROCESS FOR PREPARING A MOULDED PRODUCT

(76) Inventors: Roland Anthony Tacken, Geldrop (NL); Renatus Marius De Zwart, Eindhoven (NL); Arjan Hovestad, PK's-Hertogenbosch (NL)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/675,983

(22) PCT Filed: Sep. 5, 2008
(86) PCT No.: PCT/NL08/50585

§ 371 Date: May 13, 2010

(30) Foreign Application Priority Data
Sep. 5, 2007 (EP) 07115730.9

(51) Int. Cl. B32B 15/08; B29C 65/72

(52) U.S. Cl. 428/357; 264/241

(57) ABSTRACT

The invention provides a process for preparing a moulded product on which or in which a layer of a metal or alloy thereof is applied, in which process use is made of a mould, which process comprises a moulding step and a metallising step, wherein the moulding and metallising step are both carried out in the mould, wherein said metallising step comprises can electroless process. The invention further relates to a device comprising the moulded product obtained by said process.

The present invention relates to a process for preparing a moulded product on which a layer of a metal or alloy thereof is applied, and to a device comprising a moulded product as prepared with said process.

It is known in the art to provide the surface of a moulded product with a metallic pattern. Such moulded products can be prepared by subjecting a product obtained from a moulding process to a metallising step in the form of a wet, electrochemical process, whereby a metallic pattern is produced on the surface of the moulded product. Obviously, such a sequence of process steps is not very attractive in mass production applications where speed and costs play important roles.

Object of the present invention is to provide an improved process for preparing moulded products having a metallic pattern on their external and/or internal (e.g. cavities or channels) surfaces.

Surprisingly, it has been found that this can be realized by carrying out the moulding step and the metallising step both in one and the same mould.

Accordingly, the present invention relates to a process for preparing a moulded product on which or in which a layer of a metal, an alloy thereof or a metal compound is applied, in which process use is made of a mould, which process comprises a moulding step and a metallising step, wherein the moulding and metallising step are both carried out in the mould, and wherein the metallising step comprises an electroless process.

The process according to the present invention is more attractive than the known process since it allows the production of moulded products with a metallic pattern at a higher speed and at less cost. Moreover, internal metallised surfaces can be created having more design freedom.

In one embodiment of the present invention, first the moulding step is carried out in the mould and subsequently the moulded product so obtained is subjected to the metallising step in the mould.

In the metallising step use is made of an electroless process, such as electroless plating. In an electroless plating process use is made of the principle that a metal which is available in ionic form in solution can be reduced by a reducing agent into its metallic form on a suitable surface. Moreover, the metal itself should also be catalytic to the reduction reaction, rendering the process autocatalytic as such. For a general description on electroless plating processes reference can, for instance, be made to Electroless Plating Fundamentals & Applications, edited by Glenn 0. Mallory and Juan B. Hajdu, New York (1990).

In other suitable embodiments of the present invention use is made of metal paste, i.e. a paste comprising metal particles and a binder material, or a conductive paint or ink.

The metallising step comprises an electroless process, such as electroless plating.

In a suitable metallising step according to the present invention, an electroless solution which comprises metal ions and a reducing agent for reducing the metal ions into the metal or alloy is contacted with the moulded product, whereby at least the surface of the moulded product has a temperature (T1) or is heated to a temperature (T1) which is higher than the temperature (T2) of the solution. In such an embodiment, T1 can suitable range between 50-200° C., and T2 can suitably range between 15-90° C. This has the advantage that no metal catalyst needs to be applied on the substrate surface to initiate and catalyse the metallisation process. Moreover, metal deposition is rapid because of the high temperatures applied.

Hence, preferably in the metallising step use is made of a solution that comprises metal ions and a reducing agent for reducing the metal ions into the metal, enabling the metal to be deposited at the surface of the product to be prepared.

In another embodiment of the present invention, first the solution which comprises the metal ions and the reducing agent is introduced into the mould, and subsequently the material from which the moulded product is to be prepared is introduced into the mould.

It will be appreciated that in such an embodiment the moulded product is at least partly released from the inner wall of the mould, allowing the solution comprising the metal ions and the reducing agent to flow between at least part of the moulded product and the inner wall of the mould.

In order to allow a particular metallic pattern to be deposited on at least part of the surface of the mould, the solution comprising the metal ions and reducing agent put in contact with particular parts of the surface of the moulded products by way of a variety of cavities of the mould. In this way a variety of metallic patterns can be realized. Such techniques are as such well known in the art of multi-component moulding, gas-assisted injection moulding and core pulling techniques.

In an experimental setup the metallisation fluids may be transferred from containers into the mould using pumps to transfer the metallisation fluids through tubing into the mould. Mould parts can suitably be coated to prevent damaging the mould surface by metallisation fluids. More specifically, it has been found that a DLC (diamond like carbon) coating is suitable for this purpose.

In an embodiment of the present invention fluid buffers, pumps and tubing are physically integrated in the mould.

Clogging of the metallisation fluids circuitry (tubing, pumps, cavities) can be prevented by proper design and material selection of the components used. More specifically, it has been found that a periodic cleaning step of the fluidic system, e.g. by purging with concentrated nitric acid, is suitable to prevent clogging of the fluidic system. When steel moulds are used in combination with copper metallisation, for example, it can be advantageous to purge with concentrated nitric acid, since the copper dissolves fast and the steel passivates in the nitric acid solution.

The metallisation step may comprise a catalyst seeding step. When the metallisation step comprises a catalyst seeding step, the catalyst seeding material can either be incorporated in the injection moulded material or additionally applied in via a fluid prior to the electroless process in the mould. This can be done in the same fluid circuitry that is used for metallisation.

Catalyst seeding may be omitted to trigger the electroless deposition reaction thermally, as described in the non-prepublished European patent application No. 07115730.9. In this case, there is also no need of a catalyst in the material from which the moulded product is made.

To obtain good adhesion between moulded material and metal, it may be advantageous in some cases to execute a wet etching step prior to (facultative) catalyst application and subsequent electroless metallisation. By etching the injection moulded materials, e.g. a plastic, can be activated and/or roughened to obtain a densely catalyst surface and/or a well adherent metal film. The etching fluid may be applied through the same tubing as the metallisation fluids.

The material from which the moulded product is made can be selected from thermoplast, thermoset and ceramic materials. Preferably, the material from which the moulded product is made comprises a thermoplast material.

Suitable examples of thermoplast materials include liquid crystal polymer (LCP), polyamide (PA6, PA6,6, PA4,6, or PA12), poly(phenylene sulphide) (PPS), polyetherimide (PEI), polybutylene terephthalate (PBT), syndiotactic polystyrene (SPS), polyethylene terephthalate (PET) polycarbonate (PC), acrylonitrile-butadiene-styrene (ABS), PC/ABS, polypropylene (PP), and polyethylene (PE). Preferably, the thermoplast material comprises LCP, polyamide, PEI, PET, ABS or PC/ABS.

Suitable examples of thermoset materials include epoxies, melamine, bakelite, and polyester. Suitable examples of ceramic materials include alumina, zirconia, silica, and glass.

The metal or the alloy to be applied on the moulded product can suitably be selected from the group consisting of copper, nickel, tin, silver, gold, or any alloy thereof, and nickel-phosphorous and nickel-boron.

Preferably, the metal is copper.

Preferably, the alloy is nickel-phosphorous or nickel-boron.

The reducing agent to be used in accordance with the present invention is preferably selected from the group consisting of formaldehyde, hypophosphite, dimethylaminoborane or sodium borohydride. More preferably, the reducing agent is formaldehyde.

The layer of the metal or the alloy to be applied on the moulded product can suitably have a thickness of 100-10 000 nm, such as 1000-10 000 nm.

The contact temperature of the surface of the moulded product and the metallising solution (i.e. the solution comprising the metal ions and the reducing agent) can suitably be in the range from 50-150° C.

Suitably, the metallising solution is preheated to a temperature in the range of from 20-80° C.

In accordance with the present invention, the moulding step is carried out for a period of time ranging from 1 second to 1 minute.

Suitably, the metallising step is carried out for a period of time ranging from 1 second to 30 seconds.

By means of the process according to the present invention, a wide variety of moulded products on which a metallic pattern is applied can be prepared. Suitable examples of such products include, but are not limited to, three-dimensional electric circuits and articles such as bathroom articles, reflectors, jewellery, reflectors, toys or decorative articles.

Further, the present invention also relates to a device comprising a moulded product obtained in accordance with the present process.

Preferably, the present invention also provides an electric device comprising a moulded product as prepared with a process according to the present invention.

1. A process for preparing a moulded product on which or in which a layer of a metal or alloy thereof is applied, in which process use is made of a mould, which process comprises a moulding step and a metallising step, wherein the moulding and metallising step are both carried out in the mould, and wherein said metallising step comprises an electroless process.

2. A process according to claim 1, wherein first the moulding step is carried out and subsequently the moulded product so obtained is subjected to the metallising step.

3. A process according to claim 1, wherein in the metallising step use is made of a solution that comprises metal ions and a reducing agent for reducing the metal ions into the metal, enabling the metal to be deposited at the surface of the product to be prepared.

4. A process according to claim 3, wherein first the solution is introduced into the mould and subsequently the material from which the moulded product is to be prepared is introduced into the mould.

5. A process according to claim 1, wherein the material from which the moulded product is made comprises a thermoplast material, a thermoset material or a ceramic material.

6. A process according to claim 3, wherein the contact temperature of the surface of the moulded product and the metallising solution is in the range from 50-150° C.

7. A process according to claim 3, wherein the metallising solution is preheated to a temperature in the range of from 20-80° C.

8. A process according to claim 1, wherein the moulding step is carried out for a period of time ranging from 1 second to 1 minute.

9. A process according to claim 1, wherein the metallising step is carried out for a period of time ranging from 1 second to 30 seconds.

10. A process according claim 1, wherein the metallisation step comprises catalyst seeding before said electroless process.

11. A process according to claim 1, wherein the material from which the moulded product is made comprises a catalyst.

12. A process according to claim 1, wherein the electroless process is triggered thermally.

13. A process according to claim 1, further comprising a wet etching step prior to the metallising step.

14. A process according to claim 5, wherein the thermoplast material is selected from the group consisting of liquid crystal polymer (LCP), polyimide (PA6, PA6,6, PA4,6, or PA12), poly(phenylene sulphide) (PPS), polyetherimide (PEI), polyethylene terephthalate (PET), polybutylene terephthalate (PBT), syndiotactic polystyrene (SPS), polycarbonate (PC), acrylonitrile-butadiene-styrene (ABS), PC/ABS, polypropylene (PP), and polyethylene (PE).

15. A process according to claim 14, wherein the thermoplast material comprises LCP, polyimide, PEI, PET, ABS or PC/ABS.

16. A process according to claim 5, wherein the thermoset material is selected from the group consisting of epoxies, melamine, Bakelite and polyester.

17. A process according to claim 5, wherein the ceramic material is selected from the group consisting of alumina, zirconia, silica and glass.

18. A process according to claim 1, wherein the metal or alloy is selected from the group consisting of copper, nickel, tin, silver, gold, or any alloy thereof, and nickel phosphorous and nickel boron.

19. A process according to claim 18, wherein the metal is copper.

20. A process according to claim 18, wherein the alloy is nickel-phosphorous or nickel-boron.

21. A process according to claim 3, wherein the reducing agent is selected from the group consisting of formaldehyde, hypophosphite, dimethylaminoborane or sodium borohydride.

22. A process according to claim 21, wherein the reducing agent is formaldehyde.

23. A process according to claim 1, wherein the layer of the metal or alloy thereof has a thickness of 100-10 000 nm.

24. A process according to claim 1, wherein the mould is coated with a diamond like carbon coating.

25. A process according to claim 3, which is a continuous process, wherein a fluids circuitry for introducing said solution into the mould is periodically cleaned, preferably by purging with concentrated nitric acid.

26. A process according to claim 3, wherein said solution is contacted with the moulded product, whereby at least the surface of the moulded product has a temperature (T1) or is heated to a temperature (T1) which is higher than the temperature (T2) of the solution.

27. A device comprising a moulded product as prepared with a process according to claim 1.

28. A device according to claim 27, which device is an electric device.
